(19) United States
(12) Patent Application Publication
(10) Pub. No.: US 2007/0018944 A1
(43) Pub. Date: Jan. 25, 2007

(54) Electrophoretic display panel

(75) Inventors: Mark Thomas Johnson, Eindhoven (NL); Rogier Hendrikus Magdalen Cortie, Eindhoven (NL); Guofu Zhou, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/564,418

(22) PCT Filed: Jul. 9, 2004
(86) PCT No.: PCT/IB04/51183

§ 371 Date: Jan. 11, 2006

(30) Foreign Application Priority Data
Jul. 14, 2003 (EP) 03102139.7

(51) Int. Cl. G09G 3/34

(52) U.S. Cl. 345/107

(57) ABSTRACT

This invention relates to an electrophoretic display panel (1), for displaying a picture corresponding to image information, comprising a plurality of pixels (2), each containing an amount of an electrophoretic material comprising a first and a second type of particles (6, 7), having mutually different charges, being dispersed in a fluid, a first and a second electrode (8, 9) associated with each pixel (4) for receiving a potential difference as defined by an update drive waveform; and drive means (10), for controlling said update drive waveform of each pixel (4); said update drive waveform comprising a reset portion (R), during which a reset signal is applied over the pixel, and subsequently a driving portion (D), during which a picture potential difference is applied over the pixel for enabling the particles (6, 7) to occupy the position corresponding to the image information. The invention is characterised in that said reset portion (R) of the update drive waveform is configured so that the first and second types of particles (6,7) are brought in close proximity with each other during said reset portion (R) of the update waveform.

This invention relates to an electrophoretic display panel, for displaying a picture corresponding to image information, comprising; a plurality of pixels, each containing an amount of an electrophoretic material comprising a first and a second type of electrophoretic particles, having mutually different charges, the particles being dispersed in a fluid; a first and a second electrode means associated with each pixel for receiving a potential difference; and drive means, for controlling said potential difference of each pixel; wherein the charged particles, depending on the applied potential difference, are able to occupy a position being one of extreme positions near the electrodes and intermediate positions in between the electrodes for displaying the picture, and wherein said potential difference is controlled to be, during a reset portion, a reset potential difference having a reset value and a reset duration for enabling particles to substantially occupy one of the extreme positions, and subsequently, during a driving portion, a picture potential difference for enabling the particles to occupy the position corresponding to the image information.

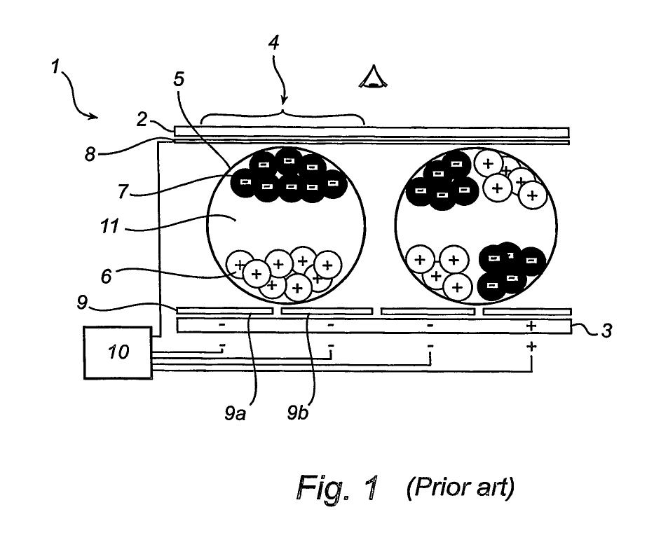

Electrophoretic display devices are based on motion of charged, usually coloured particles under the influence of an electric field. Such displays are suitable in paper-like display functions, such as electronic newspapers and electronic diaries. One type of electrophoretic display device comprises a plurality of microcapsules which are filled with a fluid. Each microcapsule also comprises a plurality of charged particles, the positions of which are controlled by the application of an electric field over the microcapsule. This is usually made by sandwiching a layer of microcapsules between a first and a second electrode. In a basic embodiment, coloured particles, such as black particles are dispersed in a white fluid (hereinafter referred to as one-particle type). Alternatively, at least two different types of coloured particles, having different charges, for example black negatively charged particles and white positively charged particles, are dispersed in a clear fluid (hereinafter referred to as two-particle type). This latter alternative is advantageous in that it allows sub-pixel addressing, which improves the resolution of the display. A detail from a display of the latter type is shown schematically in FIG. 1.

An example of an electrophoretic display device as mentioned above is described in the Patent application WO 02/07330 (one-particle type).

In the described electrophoretic display panel, each picture element has, during the display of the picture, an appearance determined by the position of the particles in each microcapsule. Hence, greyscales in such a display are generally created by applying a sequence of voltage pulses, referred to as an update drive waveform over each picture element for a specific time period. A large number of greyscales are desired for displaying a picture which looks natural. For this purpose, a variety of different update drive waveforms has been developed in order to generate different greyscales. A problem with this kind of display is however that the position of the particles do not only depend on the applied potential difference or waveform, but also on the history of the previously applied potential difference of each picture element. Moreover, the accuracy of the greyscales in electrophoretic displays is strongly influenced by other factors, such as the dwell time, temperature, humidity, and lateral imhomogenity of the electrophoretic material. Most of the developed update drive waveforms require that the greyscale level of each picture element in an image to be displayed is compared to its state in the present image, and based upon this comparison, one of a series of waveforms is selected. Hence, in an example with four grey levels, it is necessary to store sixteen different wave forms, i.e. one wave form from each transition from any one to any one of the four grey levels. Grey levels in two-particle type displays are generated in a similar manner.

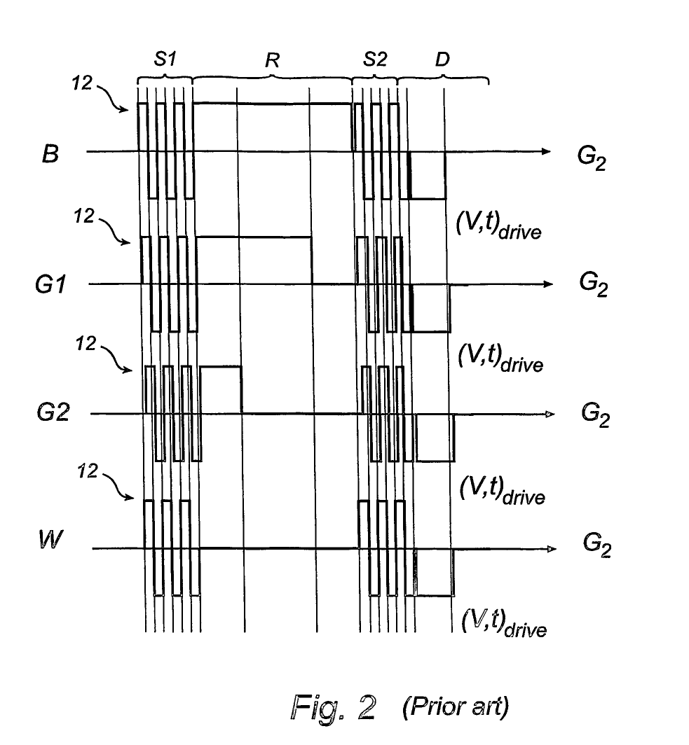

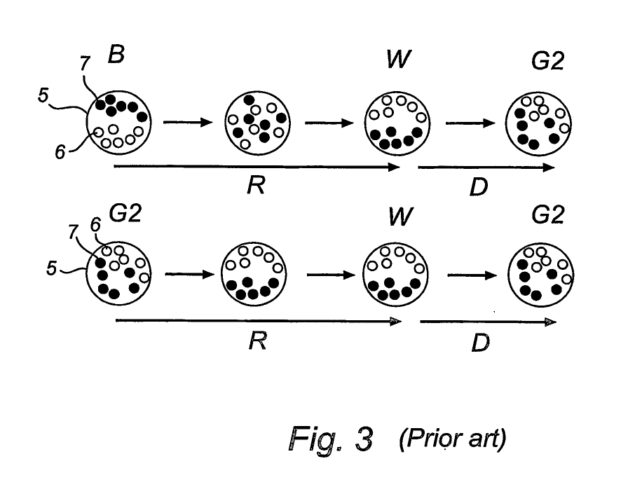

Accurate grey levels in the above types of electrophoretic displays may be achieved using a so-called rail-stabilized approach, which means that the grey levels are achieved either from a reference black state or from a reference white state (i.e. the two rails). An example of such driving waveforms, as disclosed in a currently co-pending application with the application number PHNL030091 are schematically disclosed in FIG. 2, for image transitions to the state light grey (G2) from the states black (B), dark grey (G1), light grey (G2) and white (W), respectively. Four transitions to G2 state from W, G1, G2 and B are realised using four types of update drive waveforms using over-reset for resetting the display: Longer sequence for the transitions from G1 or B to G2 and the shorter sequence for G2 or W to G2. Each update drive waveform essentially comprises a first shake period (S1), a reset period (R), a second shake period (S2) and a drive period (D). Schematic examples of the particle distribution in a microcapsule in a transition from B to G2 and from G2 to G2 according to the above prior art driving are disclosed in FIG. 3. The above co-pending application PHNL030091 discloses in one embodiment shaking pulses (also referred to as the preset pulse) which occur during the shaking period. Preferably, the shaking pulse comprises a series of AC-pulses. However, the shaking pulse may also comprise a single preset pulse only. Each level (which is one preset pulse) of the shaking pulse has an energy (or a duration if the voltage level is fixed) sufficient to release particles present in one of the extreme positions, but insufficient to enable said particles to reach the other one of the extreme positions.

However, a disadvantage of this method it that the transition from either G2 or W have a much broader brightness distribution in time as compared to transitions form G1 or B. Hence, the transitions from G2 or W essentially define the accuracy of the grey levels of the display.

Hence, an object of this invention is to achieve an electrophoretic display panel overcoming the above problems with the prior art. Another object is to improve the accuracy of grey scale reproduction for an electrophoretic display.

The above and other objects are at least in part achieved by an electrophoretic display panel by way of introduction, characterised in that said reset portion of the update drive waveform is configured so that the first and second types of particles are brought in close proximity with each other during said reset portion of the update waveform. Hence, it is possible to achieve a mixing of the two types of particles, so that the particles are brought into close proximity with each other during an image update period. In this way, it is possible to reduce the amount of image retention in the display, or to increase the number of grey levels that may be rendered by the display. In this context it shall be noted that the above mixing need only be introduced into a sub-set of all update drive forms needed to control all possible transitions of the display, since in the remaining subset, the desired mixing is achieved without extra alterations of the drive waveform. Hence, in a display panel fully utilizing the present invention, the desired mixing is performed in each update drive waveform in all pixels for any transition.

Preferably, said reset portion is configured so that it is bi-polar, i.e. comprises only a first and a second, subsequent reset signal portion, one of said signal portions being a positive pulse and the other one being a negative pulse. Moreover, the update drive waveform further comprises at least one shaking portion, and wherein said positive and negative reset signal portion each has a duration that is longer than said at least one shaking portion. Further, said first reset signal portion is shorter than said subsequent second reset signal portion. Suitably, said first pulse is arranged to move said first and a second type of particles in a direction away from the extreme positions in order to achieve said mixing.

Suitably, the duration of the first signal portion (R1) is chosen so that the total duration of that reset portion equals the length of the longest monopolar reset portion needed for a transition in the pixel. Hence, the total length of the bi-polar reset pulse may be maximised, which results in improved accuracy of the final grey level.

The above and other objects of this invention are also achieved by a method for driving an electrophoretic display device, the device comprising a plurality of pixels, each containing an amount of an electrophoretic material comprising a first and a second type of particles, having mutually different charges, being dispersed in a fluid, a first and a second electrode associated with each pixel for receiving a potential difference; and drive means, for controlling said potential difference of each pixel; wherein the charged particles, depending on the applied potential difference, are able to occupy a position being one of extreme positions near the electrodes and intermediate positions in between the electrodes for displaying the picture, and wherein said potential difference is controlled to be: during a reset portion, a reset potential difference for enabling particles to substantially occupy one of the extreme positions, and subsequently during a driving portion, a picture potential difference for enabling the particles to occupy the position corresponding to the image information, the method comprising the steps of during said reset portion applying a reset signal over said pixel, during which the first and second type of particles are brought in close proximity with each other. In the same way as described above, the inventive method assures that the desired mixing is performed in each update drive waveform in all pixels for any transition.

The above and other objects of this invention are also achieved by a drive means for driving an electrophoretic display device, the device comprising a plurality of pixels, each containing an amount of an electrophoretic material comprising a first and a second type of particles, having mutually different charges, being dispersed in a fluid; a first and a second electrode associated with each pixel for receiving a potential difference; and the drive means being arranged for controlling said potential difference of each pixel; wherein the charged particles, depending on the applied potential difference, are able to occupy a position being one of extreme positions near the electrodes and intermediate positions in between the electrodes for displaying the picture, and wherein said potential difference is controlled to be: during a reset portion, a reset potential difference for enabling particles to substantially occupy one of the extreme positions, and subsequently during a driving portion, a picture potential difference for enabling the particles to occupy the position corresponding to the image information, the drive means being further arranged for applying, during said reset portion, a reset signal over said pixel, during which the first and second type of particles are brought in close proximity with each other. In the same way as described above, the inventive drive means assured that the desired mixing is performed in each update drive waveform in all pixels for any transition.

Other advantages of the present invention are defined by the appended claims, and are described in closer detail herein.

This invention will hereinafter be described in closer detail by means of preferred embodiments thereof, with reference to the accompanying drawings.

FIG. 1 is a schematic cross-section view of two adjacent microcapsules in a display device according to the prior art, and to which the present invention may be applied.

FIG. 2 is a diagram over examples of prior art waveforms used to drive a microcapsule as disclosed in FIG. 1.

FIG. 3 is a schematic cross-section drawing depicting the movement of coloured particles within a microcapsule when driven with two of the prior art waveforms disclosed in FIG. 2.

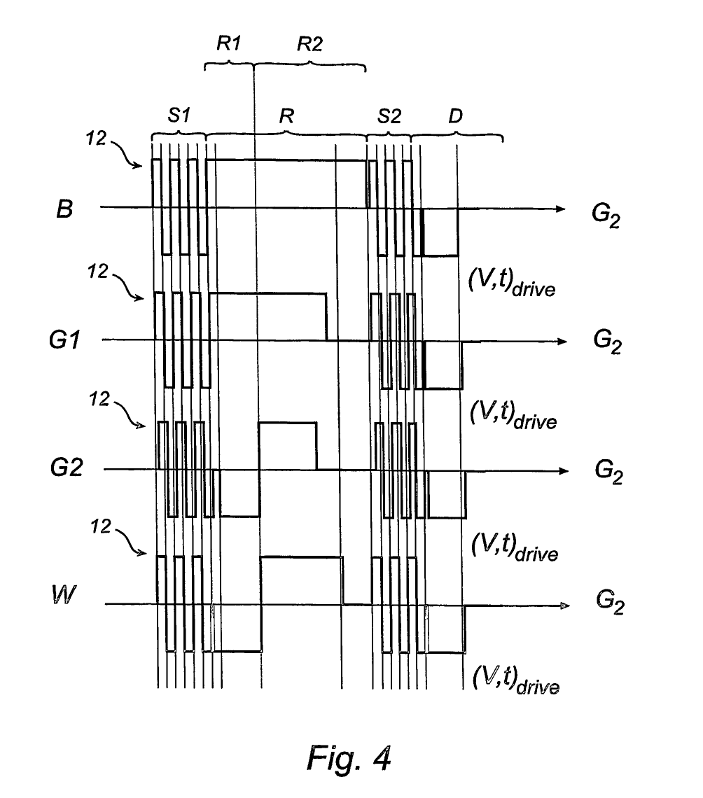

FIG. 4 is a diagram disclosing a set of drive waveform examples according to a first embodiment of this invention.

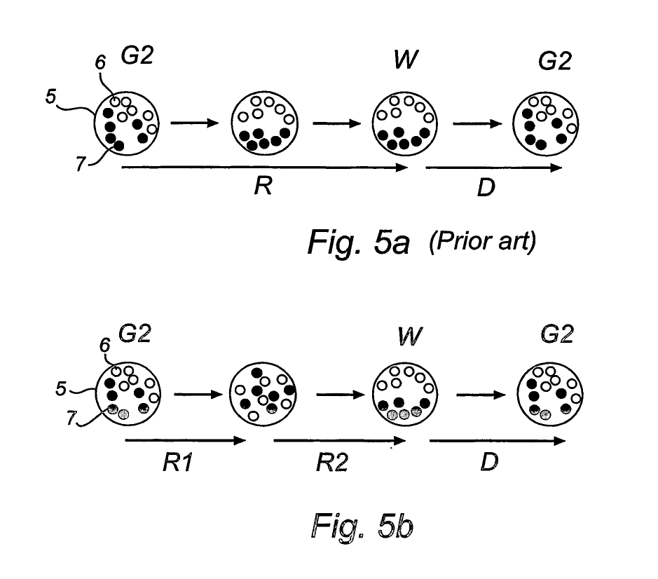

FIG. 5 is a schematic cross-section drawing depicting the movement of coloured particles within a microcapsule when driven with a waveform according to this invention (FIG. 5b) and a corresponding waveform according to the prior art (FIG. 5a).

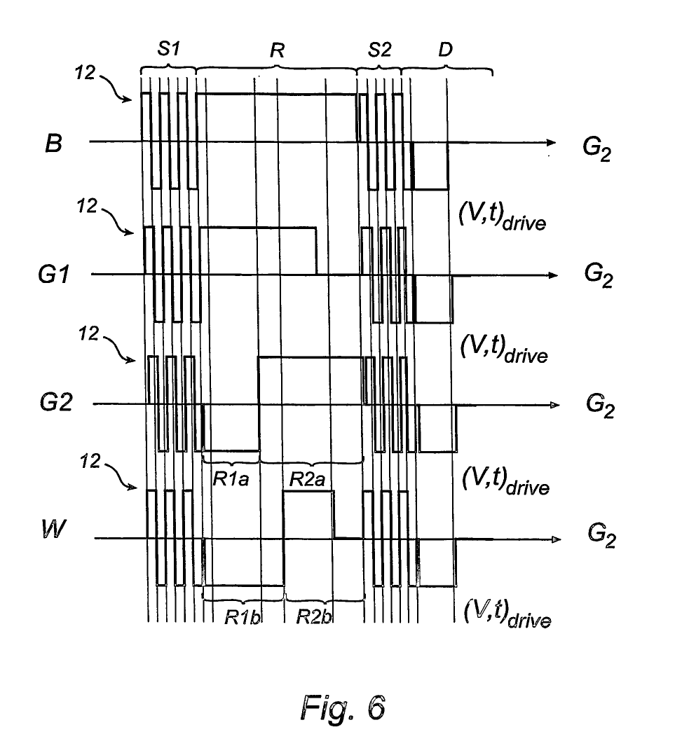

FIG. 6 is a diagram disclosing a set of drive waveform examples according to a second embodiment of this invention.

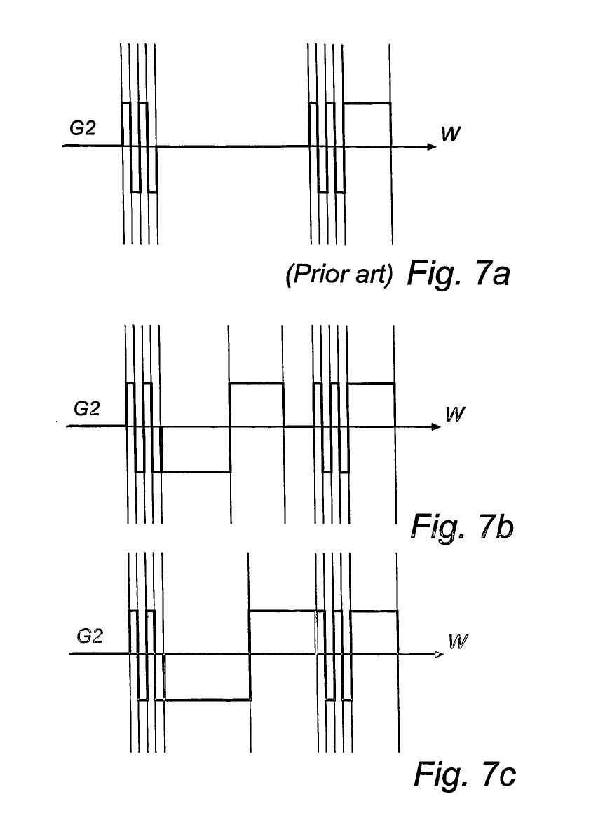

FIG. 7 is a diagram disclosing an example waveform according to the prior art (FIG. 7a) as compared to yet a variant of the embodiment disclosed in FIG. 4 (FIG. 7b) and another variant of the embodiment disclosed in FIG. 5 (FIG. 7c).

FIG. 1 shows an embodiment of an electrophoretic display panel 1, to which the present invention may be applied. The display panel 1 comprises a first transparent substrate 2, a second opposite substrate 3 and a plurality of pixels 4, each in this case being constituted by a microcapsule 5. Each microcapsule contains an electrophoretic material, such as an amount of light particles 6 and dark particles 7, suspended in a clear fluid. Electrophoretic materials for use in the microcapsules are known in the prior art and will therefore not be closer described herein. The light particles 6 and the dark particles 7 are mutually different charged. In this example the light particles are essentially white, positively charged particles, while the dark particles are essentially black, negatively charged particles. The electrophoretic display panel 1 further comprises a first electrode means 8 and a second electrode means 9, associated with each pixel 4. The electrodes 8, 9 are connected to a driver 10 in order to receive a potential difference. The driver 10 is arranged to provide the electrodes 8,9 with a suitable update drive waveform in order to control the applied potential difference. Further, the second electrode means 9 for each pixel 4 may or may not comprise two individually controllable electrodes 9a, 9b (see FIG. 1), in order to provide sub-pixel resolution. In an active matrix embodiment, each pixel 4 further comprises switching electronics (not shown) on per se known manner, comprising for example thin film transistors (TFTs), diodes or MIM devices.

By applying an update drive waveform, and hence a varying potential difference, over the electrodes 8,9, the charged particles 6, 7 within the microcapsule 5 may be moved within the microcapsule in order to occupy different parts thereof, hence changing the visual appearance of the microcapsule. Depending on the size of the applied potential difference, the charged particles 6, 7 may be moved between a first and a second extreme position, giving rise to for example the visual appearances black (B) and white (W), and may also be moved to intermediate positions, giving rise to for example the visual appearances light grey (G2) and dark grey (G1). Of course, a larger amount of grey scales may be achieved, but for clarity, this description is focused on a device which has for states, i.e. B, W, G1 and G2. In order to transfer each of said states to every other state, 16 specific transition drive waveforms are used, one for each transition. Hence, the driver 10 is arranged to control the potential difference applied over each pixel by applying a suitable one of said drive waveforms over the pixel in order to transition the pixel from a first to a second state. Each drive waveform or pulse sequence essentially consists of four waveform portions, a first shaking pulse portion S1, having a duration t_{S1}, a reset portion R, having a duration t_{R}, a second shaking portion S2, having a duration t_{S2} and a greyscale driving portion D, having a duration t_{D}. As indicated above, an example of four such drive waveforms according to the prior art are shown in FIG. 3. However, it has been noted that the brightness achieved when driving the pixel with the different waveforms differs. This means for example that the brightness for a pixel at the state G2 depends on what state the pixel where in previously, and the brightness distribution for different transitions is relatively broad.

This invention is based on the realisation that the difference between drive waveforms with narrow and broad distribution is that the narrow distributions correspond to transitions where light particles 6 and dark particles 7 have crossed each other, or in any other way have been in close contact with each other, within the microcapsule 5 during an image update, i.e. during the duration of an applied update drive waveform. In the prior art, for transitions from G1 or B to G2 (FIG. 3a), the particles first cross each other during the reset portion R, at which point the pixel appears W. Subsequently the particles are driven to the light grey level G2 with high accuracy. In contrast (FIG. 3b), in the G2 or W to G2 transitions, the white particles never cross the black particles, and a wide distribution appears, as described above.

Also, it has been noted that there is a further improvement in the grey level accuracy if the black and white particles have crossed each other in a previous image update. For example, for a transition from W to G2, we also find a more narrow distribution if the previous image update to W was from B or G1, than for if the previous image update was from G2 or W.

Hence, according to the invention, in order to reduce the width of the distribution and to improve the accuracy of greyscale reproduction for an electrophoretic display based on the principle of two types of particles charged with opposite polarity, a subset of all waveforms are intentionally extended by applying a bi-polar pulse sequence during the reset portion R of the update drive waveform. As an example, the reset portion R in accordance with this invention may be constituted by a negative pulse R1 followed by a positive pulse R2. In this way the two types of electrophoretic particles 6, 7 are brought into close proximity with each during each image update period. In this way, it is possible to reduce an amount of image retention in the display or to increase the number of grey levels that the electrophoretic display may render.

### EXAMPLE 1

Improved Bi-Polar Over-Reset Waveform

In a first embodiment of this invention, each update drive waveform of the set of update drive waveforms are designed so that the particles 6, 7 are forced to mix during the reset portion R of each update drive waveform. For some transitions, such as the transition from B to G2 disclosed in FIG. 3, this is achieved without alteration of the prior art construction. However, for a subset of the update drive waveforms this is achieved in accordance with the invention by applying a bi-polar reset waveform during the reset portion R of the update drive waveform (see FIG. 4). In this way, particle mixing is achieved also for those update drive waveforms for which this does not occur naturally (see FIGS. 5a and 5b). In the example illustrated in FIG. 4, the reset portion R of the update drive waveforms for the transitions from G2 or W to G2 initially comprises a negative voltage pulse R1, followed by a positive voltage pulse R2, which is required to set all pixels in a white state before applying the final grey level during the drive portion D. The additional negative voltage pulse is required to ensure that the light particles 6 and the dark particles 7 first move towards each other, whereby they come into close proximity with each other and whereafter the direction of movement of the particles 6,7 is reversed by the application of the positive voltage pulse R2 (see FIG. 5b).

By introducing the inventive bipolar reset portion into the update drive waveform, it has been shown that the width of the G2 distribution may be reduced from 5.3L* to 2.9L*. In this case the negative voltage pulse R1 had a duration t_{R1} of approximately 100 ms. A smaller but still significant improvement from 2.3L* to 2.0L* has also been shown when adding a short, in this case positive voltage pulse to the transition to the G1 level, also in this case making the reset portion of the update drive waveform bipolar.

### EXAMPLE 2

Improved Bi-Polar Over-Reset Waveform having an Optimal Length

It is noted that the longer the first pulse, i.e. the pulse causing the mixing (in the example above, the negative pulse R1), the more accurate the final grey level may be made.

However, in a preferred embodiment of this invention, the total image update time, i.e. the total length of the longest update drive waveform in the set of update drive waveforms remains constant. In the prior art example disclosed in FIG. 2, the total image update time is hence defined by the longest update drive waveform, in this example for the transition from B to G2, or more general, by the update drive waveform going from an extreme state to an intermediate grey level, closest to the opposite extreme state.

By the invention, this may be achieved by confining the reset waveform to a time period given by the longest reset time of the prior art waveforms. This is illustrated in FIG. 6. In this way, the length of the bipolar reset pulses may be made maximal.

### EXAMPLE 3

Additional Waveform Examples

In FIG. 7a-7c, a further waveform example, in the present case for the transition between G2 to W, is disclosed. FIG. 7a discloses a waveform according to the prior art, i.e. a waveform that may belong to the same set of waveforms as the ones disclosed in FIG. 2. However, according to this invention a bi-polar reset signal may also be useful when going to a rail from the closest grey scale, in the present example from W to G2. A basic configuration of this is disclosed in FIG. 7b, which may belong to the same set of waveforms as the ones disclosed in FIG. 4. Moreover, as described in example 2 above, it is also possible to confine the reset waveform to a time period given by the longest reset time of the prior art waveforms, and this is illustrated in FIG. 7c, which may belong to the same set of waveforms as the ones disclosed in FIG. 6.

1. An electrophoretic display panel (1), for displaying a picture corresponding to image information, comprising:
a plurality of pixels (2), each containing an amount of an electrophoretic material comprising a first and a second type of particles (6, 7), having mutually different charges, being dispersed in a fluid (11);
a first and a second electrode (8, 9) associated with each pixel (4) for receiving a potential difference as defined by an update drive waveform; and
drive means (10), for controlling said update drive waveform of each pixel (4);
wherein the charged particles (6,7), depending on the applied update drive waveform, are able to occupy a position being one of extreme positions near the electrodes (8,9) and intermediate positions in between the electrodes (8,9) for displaying the picture, and wherein said update drive waveform comprises:
a reset portion (R), during which a reset signal is applied over the pixel, and subsequently
a driving portion (D), during which a picture potential difference is applied over the pixel for enabling the particles (6, 7) to occupy the position corresponding to the image information, characterized in that
said reset portion (R) of the update drive waveform is configured so that the first and second types of particles (6,7) are brought in close proximity with each other during said reset portion (R) of the update waveform.

2. An electrophoretic display panel (1) as in claim 1, wherein the reset signal applied in said reset portion (R) comprises a first signal portion (R1) and a subsequent second signal portion (R2).

3. An electrophoretic display panel as in claim 1, wherein the said reset portion (R) is configured so that it is bi-polar, i.e. comprises only a first and a second, subsequent reset signal portion (R1 and R2, respectively), one of said signal portions being a positive pulse and the other one being a negative pulse.

4. An electrophoretic display panel as in claim 3, wherein the update drive waveform further comprises at least one shaking portion (S), and wherein said positive and negative reset signal portion each has a duration that is longer than said at least one shaking portion (S).

5. An electrophoretic display panel as in claim 1, wherein said first reset signal portion (R1) is shorter than said subsequent second reset signal portion (R2).

6. An electrophoretic display panel as in claim 2, wherein said first pulse is arranged to move said first and a second type of particles (6, 7) in a direction away from the extreme positions.

7. An electrophoretic display panel as in claim 2, wherein the duration of the first signal portion (R1) is chosen so that the total duration of that reset portion equals the length of the longest monopolar reset portion needed for a transition in the pixel.

8. A method for driving an electrophoretic display device, the device comprising—a plurality of pixels (2), each containing an amount of an electrophoretic material comprising a first and a second type of particles (6, 7), having mutually different charges, being dispersed in a fluid (11);
a first and a second electrode (8, 9) associated with each pixel (4) for receiving a potential difference; and
drive means (10), for controlling said potential difference of each pixel (4);
wherein the charged particles (6,7), depending on the applied potential difference, are able to occupy a position being one of extreme positions near the electrodes (8,9) and intermediate positions in between the electrodes (8,9) for displaying the picture, and wherein said potential difference is controlled to be:
during a reset portion (R), a reset potential difference for enabling particles (6,7) to substantially occupy one of the extreme positions, and subsequently
during a driving portion (D), a picture potential difference for enabling the particles (6, 7) to occupy the position corresponding to the image information,
the method comprising the steps of:
during said reset portion (R) applying a reset signal over said pixel (4), during which the first and second type of particles are brought in close proximity with each other.

9. A method according to claim 8, wherein the reset signal applied in said reset portion (R) comprises a first signal portion (R1) and a subsequent second signal portion (R2).

10. A method according to claim 8, wherein said reset signal of said reset portion (R) is configured so that it is bi-polar, i.e. comprises only a first and a second, subsequent reset signal portion (R1 and R2, respectively), one of said signal portions being a positive pulse and the other one being a negative pulse.

11. A method according to claim 9, wherein the update drive waveform further is arranged to comprise at least one shaking portion (S), and wherein said positive and negative reset signal portion each is arranged to have a duration that is longer than said at least one shaking portion (S).

12. A method according to claim 9, wherein said first reset signal portion (R1) is shorter than said subsequent second reset signal portion (R2).

13. A method as in claim 9, wherein said first pulse is arranged to move said first and a second type of particles (6, 7) in a direction away from the extreme positions.

14. A method as in claim 9, wherein the duration of the first signal portion (R1) is chosen so that the total duration of that reset portion equals the length of the longest monopolar reset portion needed for a transition in the pixel.

15. Drive means for driving an electrophoretic display device, the device comprising
a plurality of pixels (2), each containing an amount of an electrophoretic material comprising a first and a second type of particles (6, 7), having mutually different charges, being dispersed in a fluid (11);
a first and a second electrode (8, 9) associated with each pixel (4) for receiving a potential difference; and
the drive means (10) being arranged for controlling said potential difference of each pixel (4);
wherein the charged particles (6, 7), depending on the applied potential difference, are able to occupy a position being one of extreme positions near the electrodes (8, 9) and intermediate positions in between the electrodes (8, 9) for displaying the picture, and
wherein said potential difference is controlled to be:
during a reset portion (R), a reset potential difference for enabling particles (6, 7) to substantially occupy one of the extreme positions, and subsequently
during a driving portion (D), a picture potential difference for enabling the particles (6, 7) to occupy the position corresponding to the image information,
the drive means being further arranged for applying,
during said reset portion (R), a reset signal over said pixel (4), during which the first and second type of particles are brought in close proximity with each other.
